(19) United States
(12) Patent Application Publication
(10) Pub. No.: US 2025/0083241 A1
(43) Pub. Date: Mar. 13, 2025

(54) DOUBLE RESISTOR-CAPACITOR DISCHARGE MACHINING SYSTEM

(71) Applicant: NATIONAL TAIWAN NORMAL UNIVERSITY, Taipei City (TW)

(72) Inventors: Shun-Tong Chen, Taipei City (TW); Shih-Yao Chen, Taipei City (TW)

(21) Appl. No.: 18/435,233

(22) Filed: Feb. 7, 2024

(30) Foreign Application Priority Data
Sep. 12, 2023 (TW) 112134672

(51) Int. Cl. B23H 1/02; B23H 7/16; B23H 7/20

(52) U.S. Cl. CPC B23H 1/024; B23H 7/16; B23H 7/20

(57) ABSTRACT

A double resistor-capacitor discharge machining system comprises an electrode, a discharge circuit module and a control unit. The electrode is configured to process a workpiece. The discharge circuit module comprises a first discharge circuit and a second discharge circuit. The first discharge circuit comprises a first resistor, a first capacitor and a first transistor and configured to generate a first discharge current. The second discharge circuit is connected in parallel with the first discharge circuit and includes a second resistor, a second capacitor and a second transistor to generate a second discharge current. The capacitance value of the first capacitor is greater than that of the second capacitor. The control unit is configured to respectively control the first transistor and the second transistor, and control the discharge circuit module to alternatively output the first discharge current and the second discharge current to the electrode.

### BACKGROUND OF THE INVENTION

### 1. Field of the Invention

The present invention relates to a discharge machining system, and more particularly, to a double resistor-capacitor discharge machining system having a discharge current wave train with high and low peak values.

### 2. Description of the Prior Art

In recent years, with the advancement of semiconductor, electronic and mechanical technologies, products have been developing in the direction of miniaturization and refinement. While pursuing technological advances, people are also paying more and more attention to the sustainable development of products and technologies, as well as how to minimize energy waste. Therefore, electronic products and electronic components not only need to have high power conversion to reduce energy consumption, but also need to have the characteristics of environmental protection and green energy, and electric vehicle is one of the green energy products.

The electric vehicle is mainly powered by the battery module to convert electrical energy into kinetic energy, so the electronic components in the battery module need to operate in a high power/high voltage operating environment. Gallium oxide (Ga₂O₃) has the characteristics of ultra-wide energy gap, high power, high breakdown voltage and high critical electric field, which makes it suitable for high-voltage environments and can be used as high-power electronic components. However, gallium oxide material is not easy to machine due to its high brittleness, high hardness and high melting point. Therefore, discharge machining is one of the methods for machining gallium oxide materials.

Among the existing discharge machining technologies, transistor discharge machining and single resistor-capacitor discharge machining are common machining methods. The transistor discharge machining provides high discharge energy, fast machining speeds, and high material removal rates. However, transistor discharge has the problem of time delay, which leads to too high spark melting temperature, and the workpiece will absorb too much heat energy and produce thermal deformation, which further reduces the machining accuracy and does not meet the needs of microstructural machining. The single resistor-capacitor discharge machining can generate the current with high peak value and narrow pulse time width and produce less heat energy to the workpiece, which meets the needs of microstructural machining. However, when the electrode is discharged to machine the material of the workpiece, the distance between the electrode and the workpiece becomes large. Therefore, the electrode need to move toward the workpiece gradually to a critical distance before discharging again. In other words, the undischarged time for single resistor-capacitor discharge machining is much longer than the discharged time, which leads to longer machining time and lower machining efficiency.

Therefore, it is necessary to develop a new discharge machining method to solve the problems of the prior art.

### SUMMARY OF THE INVENTION

In view of this, the present invention is to provide a double resistor-capacitor discharge machining system for machining a workpiece containing gallium oxide material. The double resistor-capacitor discharge machining system comprises an electrode, a discharge circuit module and a control unit. The electrode is configured to process the workpiece. The discharge circuit module is electrically connected to the electrode and comprises a first discharge circuit and a second discharge circuit. The first discharge circuit comprises a first resistor, a first capacitor and a first transistor. The first discharge circuit is configured to generate a first discharge current according to the first resistor and the first capacitor. The second discharge circuit is connected in parallel with the first discharge circuit and comprises a second resistor, a second capacitor and a second transistor. The second discharge circuit is configured to generate a second discharge current according to the second resistor and the second capacitor. Wherein, the capacitance value of the first capacitor is greater than the capacitance value of the second capacitor. The control unit is electrically connected to the discharge circuit module. The control unit is configured to respectively control the first transistor and the second transistor, and control the discharge circuit module to alternatively output the first discharge current and the second discharge current to the electrode.

Wherein, the control unit is a Field-Programmable Gate Array (FPGA).

Wherein, the first transistor and the second transistor are N-type field-effect transistors.

Wherein, the discharge circuit module comprises a first node and a second node. The first node is located between a power supply, the first discharge circuit and the second discharge circuit, and the first resistor is located between the first node and the first transistor. The second node is located between the first discharge circuit, the second discharge circuit and the electrode, and the second resistor is located between the first node and the second transistor. The first node is electrically connected to a drain electrode of the first transistor and the second transistor, the second node is electrically connected to a source electrode of the first transistor and the second transistor, and the control unit is electrically connected to a gate electrode of the first transistor and the second transistor.

Wherein, the discharge circuit module comprises a third node and a fourth node. The third node is located between the first resistor and the first transistor, and the first capacitor is electrically connected to the third node. The fourth node is located between the second resistor and the second transistor, and the second capacitor is electrically connected to the fourth node.

Wherein, the first discharge circuit comprises a third transistor located between the control unit and the first transistor, and the second discharge circuit comprises a fourth transistor located between the control unit and the second transistor. When the control unit respectively controls the third transistor and the fourth transistor to be in conducting state, the discharge circuit module correspondingly outputs the first discharge current and the second discharge current.

Wherein, the double resistor-capacitor discharge machining system further comprises a drive circuit module electrically connected to the control unit and the discharge circuit module. The drive circuit module generates a drive signal according to a timing signal outputted by the control unit, and the discharge circuit module outputs the first discharge current and the second discharge current according to the drive signal.

Wherein, the double resistor-capacitor discharge machining system further comprises a voltage detection module electrically connected to the electrode and pre-stores a voltage threshold. The voltage detection module is configured to measure a voltage difference between the electrode and the workpiece. The voltage detection module generates a warning signal when the voltage difference is less than the voltage threshold.

Wherein, the electrode is a wire electrode and the diameter of the electrode is 20 μm.

Wherein, the first capacitor has a capacitance value of 200 pF, and the second capacitor has a capacitance value of 100 pF.

In summary, the double resistor-capacitor discharge machining system of the present invention generates a discharge current wave train with high and low peak values. The high peak currents vaporize, explode and thermally crack the gallium oxide to remove the material of the workpiece, and the low peak currents are configured to remove deteriorated layers, residues and burrs from the machined surface of the workpiece, so as to enhance the machining accuracy and quality. In addition, the double resistor-capacitor discharge machining system of the present invention can detect the distance between the electrode and the workpiece through the voltage detection module to avoid short-circuiting and ensure that the electrodes can maintain the machining, so as to improve the machining efficiency.

### BRIEF DESCRIPTION OF THE APPENDED DRAWINGS

FIG. 1 is a function block diagram illustrating a double resistor-capacitor discharge machining system according to an embodiment of the present invention.

FIG. 2 is a circuit diagram illustrating the double resistor-capacitor discharge machining system according to an embodiment of the present invention.

FIG. 3 is a circuit diagram illustrating a first discharge circuit of the discharge circuit module according to an embodiment of the present invention.

FIG. 4A is a time sequence diagram of capacitors charging and discharging and transistors switching according to an embodiment of the present invention.

FIG. 4B is a schematic diagram illustrating a discharge current generated by the discharge circuit module according to the drive signal according to an embodiment of the present invention.

FIG. 5 is a schematic diagram illustrating the workpiece processed by the double resistor-capacitor discharge machining system of the present invention.

FIG. 6 is a function block diagram illustrating the double resistor-capacitor discharge machining system according to an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of this specification, the description with reference to the terms “an embodiment”, “another embodiment” or “part of an embodiment” means that a particular feature, structure, material or characteristic described in connection with the embodiment including in at least one embodiment of the present invention. In this specification, the schematic representations of the above terms do not necessarily refer to the same embodiment. Furthermore, the particular features, structures, materials or characteristics described may be combined in any suitable manner in one or more embodiments. Furthermore, the indefinite articles “a” and “an” preceding a device or element of the present invention are not limiting on the quantitative requirement (the number of occurrences) of the device or element. Thus, “a” should be read to include one or at least one, and a device or element in the singular also includes the plural unless the number clearly refers to the singular.

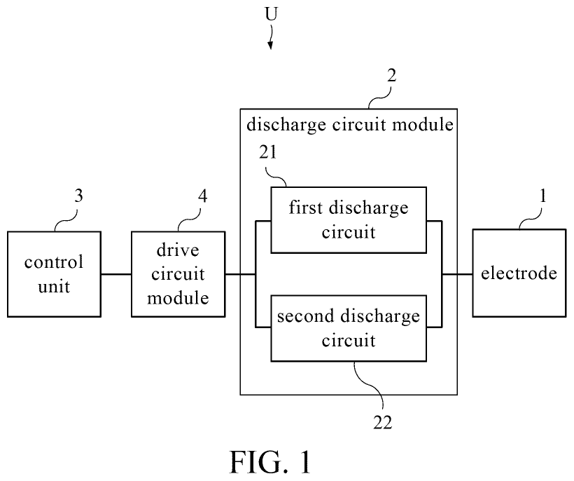

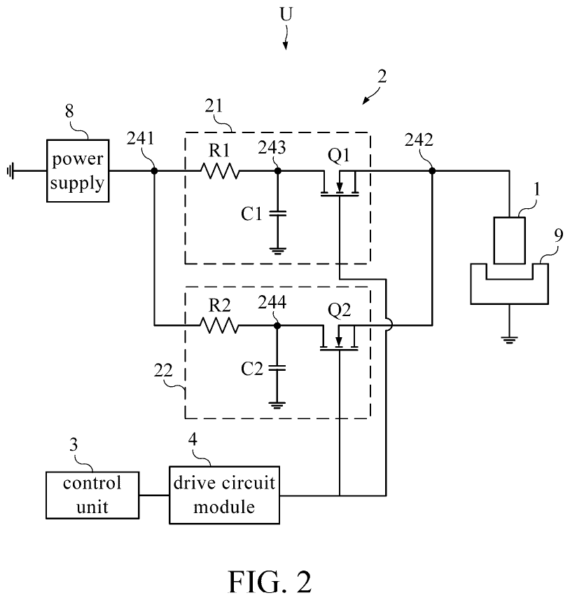

Please refer to FIG. 1 and FIG. 2. FIG. 1 is a function block diagram illustrating a double resistor-capacitor discharge machining system U according to an embodiment of the present invention. FIG. 2 is a circuit diagram illustrating the double resistor-capacitor discharge machining system U according to an embodiment of the present invention. The double resistor-capacitor discharge machining system U of the present invention processes a workpiece containing a gallium oxide (Ga₂O₃) material with high-frequency discharge to form a microstructure. As shown in FIG. 1, the double resistor-capacitor discharge machining system U comprises an electrode 1, a discharge circuit module 2 and a control unit 3. The electrode 1 is electrically connected to the discharge circuit module 2, and the discharge circuit module 2 is electrically connected to the control unit 3. The discharge circuit module 2 is configured to generate discharge currents, and the control unit 3 is configured to control the discharge circuit module 2 to output the discharge currents to the electrode 1 for discharge machining.

As shown in FIG. 2, in the present embodiment, the discharge circuit module 2 comprises a first discharge circuit 21, a second discharge circuit 22, a first node 241 and a second node 242. The first node 241 is located between a power supply 8 and the first discharge circuit 21, and located between a power supply 8 and the second discharge circuit 22. The second node 242 is located between the first discharge circuit 21 and the electrode 1, and located between the second discharge circuit 22 and the electrode 1. The first discharge circuit 21 is connected in parallel with the second discharge circuit 22.

In the present embodiment, a first discharge circuit 21 comprises a first resistor R1, a first capacitor C1 and a first transistor Q1. The first resistor R1 is located between the first node 241 and the first transistor Q1. The first node 241 is electrically connected to the drain electrode (D) of the first transistor Q1, and the second node 242 is electrically connected to the source electrode(S) of the first transistor Q1. Furthermore, the first discharge circuit 21 comprises a third node 243. The third node 243 is located between the first resistor R1 and the first transistor Q1. The first capacitor C1 is electrically connected to the third node 243. The third node 243 is electrically connected to the drain electrode of the first transistor Q1. In practice, the first node 241 can be connected to the positive pole of the power supply 8. When the power supply 8 outputs a voltage, the first capacitor C1 of the first discharge circuit 21 can store the electrical energy provided by the power supply 8, and the first discharge circuit 21 can generate a first discharge current according to the first resistor R1 and the first capacitor C1. The first discharge current generated by the first discharge circuit 21 can flow through the third node 243 to the drain electrode of the first transistor Q1.

In the present embodiment, a second discharge circuit 22 comprises a second resistor R2, a second capacitor C2 and a second transistor Q2. The second resistor R2 is located between the first node 241 and the second transistor Q2. The first node 241 is electrically connected to the drain electrode of the second transistor Q2, and the second node 242 is electrically connected to the source electrode of the second transistor Q2. Furthermore, the second discharge circuit 22 comprises a fourth node 244. The fourth node 244 is located between the second resistor R2 and the second transistor Q2. The second capacitor C2 is electrically connected to the fourth node 244. The fourth node 244 is electrically connected to the drain electrode of the second transistor Q2. In practice, when the power supply 8 outputs a voltage, the second capacitor C2 of the second discharge circuit 22 can store the electrical energy provided by the power supply 8, and the second discharge circuit 22 can generate a second discharge current according to the second resistor R2 and the second capacitor C2. The second discharge current generated by the second discharge circuit 22 can flow through the fourth node 244 to the drain electrode of the second transistor Q2.

In the present embodiment, the control unit 3 is connected to a gate electrode (G) of the first transistor Q1 and a gate electrode of the second transistor Q2. The control unit 3 is configured to control the first transistor Q1 and the second transistor Q2 to control the discharge circuit module 2 to output the first discharge current and the second discharge current. In practice, the control unit 3 is a Field-Programmable Gate Array (FPGA). The control unit 3 can input a small voltage to the gate electrodes of the first transistor Q1 and the second transistor Q2 to form a gate voltage, so as to control the drain electrodes and the source electrodes of the first transistor Q1 and the second transistor Q2 to be in non-conducting state or in conducting state. In other words, the control unit 3 can respectively control the charging or discharging of the first discharge circuit 21 and the second discharge circuit 22 through the gate electrodes of the first transistor Q1 and the second transistor Q2. For example of the first discharge circuit 21, the electrical energy generated by the first discharge circuit 21 will be stored in the first capacitor C1 when the control unit 3 controls the drain electrode and the source electrode of the first transistor Q1 to be in the non-conducting state, at this time, the first discharge circuit 21 is in the charging state. When the control unit 3 controls the drain electrode and the source electrode of the first transistor Q1 to be in the conducting state, the electrical energy stored in the first capacitor C1 will generate a conduction current (i.e., the first discharge current) flowing from the drain electrode to the source electrode, at this time, the first discharge circuit 21 is in the discharging state.

In the present embodiment, the first transistor Q1 and the second transistor Q2 are N-type field-effect transistors (N-MOSFET). When the control unit 3 controls the charging/discharging of the first discharge circuit 21 and the second discharge circuit 22 through the gate electrodes, the first transistor Q1 and the second transistor Q2 can prevent the current reversal back to the control unit 3.

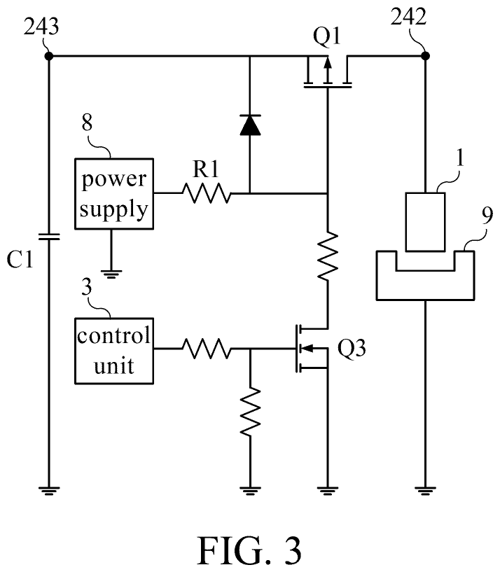

The first discharge circuit and the second discharge circuit of the present invention are not only limited to the aforementioned patterns, but can also be other patterns. Please refer to FIG. 3. FIG. 3 is a circuit diagram illustrating a first discharge circuit 21 of the discharge circuit module 2 according to an embodiment of the present invention. As shown in FIG. 3, in the present embodiment, the first discharge circuit 21 further comprises a third transistor Q3 located between the control unit 3 and the first transistor Q1. The first transistor Q1 is in the conducting state and the discharge circuit module 2 outputs the first discharge current when the control unit 3 controls the third transistor Q3 to be in the conducting state. In practice, the first transistor Q1 is a P-type field-effect transistor (P-MOSFET), and the third transistor Q3 is an N-type field-effect transistor. The source electrode of the first transistor Q1 is electrically connected to the third node 243, and the drain electrode of the first transistor Q1 is electrically connected to the second node 242. The gate electrode of the third transistor Q3 is electrically connected to the control unit 3, and the drain electrode of the third transistor Q3 is electrically connected to the gate electrode of the first transistor Q1. In practice, the first transistor Q1 can be an IRF9630, and the third transistor Q3 can be an IRF740. When the control unit 3 controls the third transistor Q3 to be in the conducting state, the gate voltage of the first transistor Q1 is lower than the drain voltage of the saturated energy, so that the first transistor Q1 will be in the conducting state and the first discharge circuit 21 will be in the discharge state.

Similarly, the second discharge circuit can further comprise a fourth transistor located between the control unit and the second transistor. The second transistor can be an IRF9630, and the fourth transistor can be an IRF740. When the control unit controls the fourth transistor to be in the conducting state, the gate voltage of the second transistor is lower than the drain voltage of the saturated energy, so that the second transistor will be in the conducting state and the second discharge circuit will be in the discharge state. Since the circuit diagram of the second discharge circuit is substantially the same as the circuit diagram of the first discharge circuit 21 of FIG. 3, it is not shown graphically and will not be repeated herein.

In another embodiment, the first transistor and the third transistor of the first discharge circuit, the second transistor and the fourth transistor of the second discharge circuit are all N-type field-effect transistor. The third transistor of the first discharge circuit and the fourth transistor of the second discharge circuit can also prevent the current reversal back to the control unit.

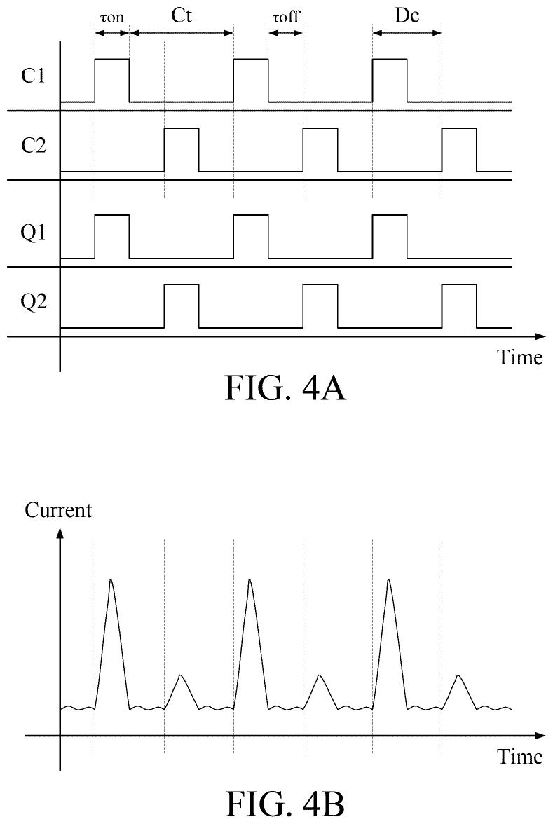

Please refer to FIG. 1, FIG. 2, FIG. 4A, and FIG. 4B. FIG. 4A is a time sequence diagram of capacitors charging and discharging and transistors switching according to an embodiment of the present invention. FIG. 4B is a schematic diagram illustrating a discharge current generated by the discharge circuit module 2 according to the drive signal according to an embodiment of the present invention. As shown in FIG. 1 and FIG. 2, in the present embodiment, the double resistor-capacitor discharge machining system U further comprises a drive circuit module 4 electrically connected to the control unit 3 and the discharge circuit module 2 and located between the control unit 3 and the discharge circuit module 2. In the present embodiment, the control unit 3 is configured to output a timing signal, and the drive circuit module 4 generates a drive signal according to the timing signal. In practice, the drive circuit module 4 can be a MOS driver and can be electrically connected to the gate electrodes of the first transistor Q1 and the second transistor Q2. When the drive circuit module 4 receives the timing signal output from the control unit 3, the drive circuit module 4 can generate the drive signal for controlling the ON/OFF of the gate electrode, and the discharge circuit module 2 switches the gate electrode ON/OFF according to the drive signal to output the discharge current.

As shown in FIG. 4A, the control unit generates and outputs timing signals of the first capacitor C1 and the second capacitor C2, respectively. As shown in FIG. 4A, the timing signals include a charging time Ct, a discharging time τon, a discharging rest time τoff, and a discharging cycle Dc. In the present embodiment, the formulas for the timing signals of the first capacitor C1 and the second capacitor C2 are as follows:

$$Ct = τ on + 2 τ off$$

$$Dc = τ on + τ off$$

Furthermore, the first capacitor C1 and the second capacitor C2 are discharged in turn in a staggered timing sequence, and the first capacitor C1 and the second capacitor C2 are discharged once for every two discharging cycles Dc, respectively. In other words, in the timing signal, the first capacitor C1 is discharged for the first discharging cycle, the second capacitor C2 is discharged for the second discharging cycle, the first capacitor C1 is discharged for the third discharging cycle, and so on. It is worth noting that the discharging time τon, the discharging rest time τoff, and the discharging cycles Dc can be determined according to the design or processing requirements (e.g., feed rate).

When the drive circuit module 4 receives timing signals of the first capacitor C1 and the second capacitor C2 output by the control unit 3, the drive circuit module 4 generates the drive signal for controlling the switching of the first transistor Q1 and the second transistor Q2 according to the timing signals. As shown in FIG. 4A, when the first capacitor C1 is at the discharging time τon, the drive circuit module 4 generates a signal that the first transistor Q1 is turn-on; and when the first capacitor C1 is at the charging time Ct, the drive circuit module 4 generates a signal that the first transistor Q1 is turn-off. Similarly, when the second capacitor C2 is at the discharging time τon, the drive circuit module 4 generates a signal that the second transistor Q2 is turn-on; and when the second capacitor C2 is at the charging time Ct, the drive circuit module 4 generates a signal that the second transistor Q2 is turn-off.

In the present embodiment, the capacitance value of the first capacitor C1 is larger than the capacitance value of the second capacitor C2. That is, the first discharge current generated by the first discharge circuit 21 is larger than the second discharge current generated by the second discharge circuit 22. Therefore, as shown in FIG. 4B, when the discharge circuit module 2 controls the switching of the first transistor Q1 and the second transistor Q2 according to the drive signal, the discharge circuit module 2 alternately outputs the first discharge current and the second discharge current and generates a discharge current wave train with high and low peak values. Furthermore, when the control unit 3 outputs the high-frequency timing signal of the capacitor charging/discharging, the discharge circuit module 2 generates a discharge current with a narrow pulse width, a high density, and an intervals between high and low peak values.

In practice, when the electrode 1 processes the workpiece 9 containing gallium oxide material with the discharge current wave train including high and low peak values generated by the discharge circuit module 2, the high peak currents vaporize, explode and thermally crack the gallium oxide to remove the material of the workpiece, and the low peak currents are configured to remove deteriorated layers, residues and burrs from the machined surface of the workpiece. Furthermore, there is a trough between the high peak current and the low peak current, and the current value of the trough is 0, and the time length of the trough is the discharging rest time τoff. That is, the melted material of the workpiece processed by the high peak current and the low peak current has enough time to be solidified into a residue, and the residue can be taken away by the dielectric fluid. The workpiece will not be processed over and over again to reduce the processing efficiency and quality.

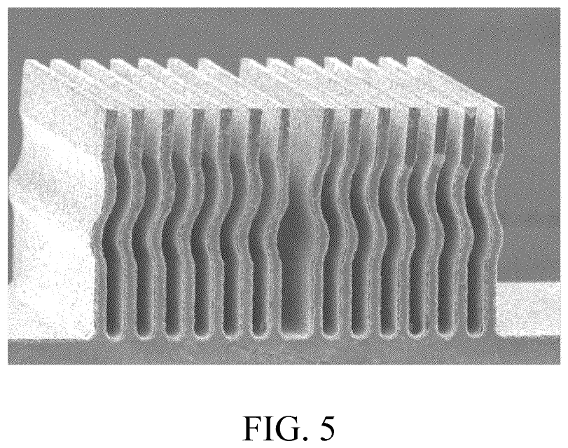

In a preferred embodiment, please refer to FIG. 5, FIG. 5 is a schematic diagram illustrating the workpiece processed by the double resistor-capacitor discharge machining system of the present invention. In the present embodiment, the electrode is a wire electrode and the diameter of the wire electrode is 20 μm, the first capacitor has a capacitance value of 200 pF, and the second capacitor has a capacitance value of 100 pF. As shown in FIG. 5, when the double resistor-capacitor discharge machining system of the present invention processes the workpiece containing gallium oxide material with a discharge current wave train with high and low peak values, the workpiece can produce a groove with a width of 25 μm and a curved fin array structure with a flat machined surface. It should be noted that the processing shape of the workpiece can be determined according to the design and requirements, and the double resistor-capacitor discharge machining system of the present invention can also machine microstructures such as field plates, trenches, and columnar structure arrays.

Accordingly, the double resistor-capacitor discharge machining system of the present invention can generate the discharge current wave train with high and low peak values. The high peak currents vaporize, explode and thermally crack the gallium oxide to remove the material of the workpiece; and the low peak currents are configured to remove deteriorated layers, residues and burrs from the machined surface of the workpiece, to enhance the machining accuracy and quality.

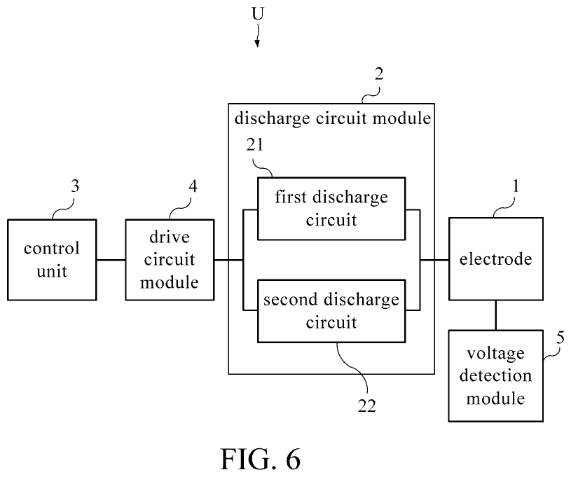

Please refer to FIG. 6. FIG. 6 is a function block diagram illustrating the double resistor-capacitor discharge machining system U according to an embodiment of the present invention. As shown in FIG. 6, in the present embodiment, the double resistor-capacitor discharge machining system U further comprises a voltage detection module 5 electrically connected the electrode 1 and the workpiece. The voltage detection module 5 is configured to measure a voltage difference between the electrode 1 and the workpiece. Furthermore, the voltage detection module 5 contains a voltage threshold. The voltage detection module 5 generates a warning signal when the voltage difference is less than the voltage threshold. In practice, the voltage detection module can be a voltage detection circuit or device. When the voltage difference is less than the voltage threshold, it indicates that the distance between the electrode 1 and the workpiece is getting closer, and there is a possibility of short-circuit discharge and machining cannot be performed. In this case, the voltage detection module 5 can generate and output a warning signal, and the operator can adjust the feed rate of the electrode according to the warning signal to ensure that the electrode can maintain machining. The voltage threshold can be determined by design or requirement. It should be noted that the other components in the FIG. 6 has substantially the same function as the corresponding element of the aforementioned embodiment, it will not be described herein.

In summary, the double resistor-capacitor discharge machining system of the present invention generates a discharge current wave train with high and low peak values. The high peak currents vaporize, explode and thermally crack the gallium oxide to remove the material of the workpiece, and the low peak currents are configured to remove deteriorated layers, residues and burrs from the machined surface of the workpiece, so as to enhance the machining accuracy and quality. In addition, the double resistor-capacitor discharge machining system of the present invention can detect the distance between the electrode and the workpiece through the voltage detection module to avoid short-circuiting and ensure that the electrodes can maintain the machining, so as to improve the machining efficiency.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A double resistor-capacitor discharge machining system for a workpiece containing gallium oxide material, comprising:
an electrode, configured to process the workpiece;
a discharge circuit module, electrically connected to the electrode and the discharge circuit module further comprising:
a first discharge circuit, comprising a first resistor, a first capacitor and a first transistor, the first discharge circuit being configured to generate a first discharge current according to the first resistor and the first capacitor; and
a second discharge circuit, connected in parallel with the first discharge circuit and comprising a second resistor, a second capacitor and a second transistor, the second discharge circuit being configured to generate a second discharge current according to the second resistor and the second capacitor, wherein the capacitance value of the first capacitor is greater than the capacitance value of the second capacitor; and
a control unit, electrically connected to the discharge circuit module, the control unit being configured to respectively control the first transistor and the second transistor, and control the discharge circuit module to alternatively output the first discharge current and the second discharge current to the electrode.

2. The double resistor-capacitor discharge machining system of claim 1, wherein the control unit is a Field-Programmable Gate Array (FPGA).

3. The double resistor-capacitor discharge machining system of claim 1, wherein the first transistor and the second transistor are N-type field-effect transistors.

4. The double resistor-capacitor discharge machining system of claim 1, wherein the discharge circuit module comprises a first node and a second node, the first node is located between a power supply, the first discharge circuit and the second discharge circuit, the first resistor is located between the first node and the first transistor, the second node is located between the first discharge circuit, the second discharge circuit and the electrode, the second resistor is located between the first node and the second transistor, the first node is electrically connected to a drain electrode of the first transistor and the second transistor, the second node is electrically connected to a source electrode of the first transistor and the second transistor, and the control unit is electrically connected to a gate electrode of the first transistor and the second transistor.

5. The double resistor-capacitor discharge machining system of claim 4, wherein the discharge circuit module comprises a third node and a fourth node. The third node is located between the first resistor and the first transistor, and the first capacitor is electrically connected to the third node. The fourth node is located between the second resistor and the second transistor, and the second capacitor is electrically connected to the fourth node.

6. The double resistor-capacitor discharge machining system of claim 4, wherein the first discharge circuit comprises a third transistor located between the control unit and the first transistor, the second discharge circuit comprises a fourth transistor located between the control unit and the second transistor, and when the control unit respectively controls the third transistor and the fourth transistor to be in conducting state, the discharge circuit module correspondingly outputs the first discharge current and the second discharge current.

7. The double resistor-capacitor discharge machining system of claim 1, further comprising a drive circuit module electrically connected to the control unit and the discharge circuit module, wherein the drive circuit module generates a drive signal according to a timing signal outputted by the control unit, and the discharge circuit module outputs the first discharge current and the second discharge current according to the drive signal.

8. The double resistor-capacitor discharge machining system of claim 1, further comprising a voltage detection module electrically connected to the electrode and pre-storing a voltage threshold, wherein the voltage detection module is configured to measure a voltage difference between the electrode and the workpiece, and the voltage detection module generates a warning signal when the voltage difference is less than the voltage threshold.

9. The double resistor-capacitor discharge machining system of claim 1, wherein the electrode is a wire electrode and the diameter of the electrode is 20 μm.

10. The double resistor-capacitor discharge machining system of claim 1, wherein the first capacitor has a capacitance value of 200 pF, and the second capacitor has a capacitance value of 100 pF.
